(19) United States
(12) Patent Application Publication
(10) Pub. No.: US 2013/0048779 A1
(43) Pub. Date: Feb. 28, 2013

(54) Emergency Food Relief Delivery of In-Shell Peanuts, and Other Delivery Systems, Products and Methods for Emergency Food Relief

(71) Applicant: Mary E. Goulet, McLean, VA (US)

(72) Inventor: Mary E. Goulet, McLean, VA (US)

(21) Appl. No.: 13/490,825

(22) Filed: Jun. 7, 2012

Related U.S. Application Data
(60) Provisional application No. 61/575,656, filed on Aug. 26, 2011.

(51) Int. Cl. B65D 81/00; B64B 1/66; B64B 1/40; B65D 79/00; B65D 81/18

(52) U.S. Cl. 244/31; 426/111; 426/87

(57) ABSTRACT

In-shell peanuts are used in a famine relief product, especially inside balloons and balloon-launching delivery systems.

### RELATED APPLICATION

Benefit is claimed to U.S. provisional patent application No. 61/575,656 filed Aug. 26, 2011.

### FIELD OF THE INVENTION

The invention relates to emergency food relief.

### BACKGROUND OF THE INVENTION

There continues to be a problem in the world with certain large populations needing food on an emergency basis, such as people migrating to escape drought conditions. Although emergency food relief organizations exist, delivery of the foodstuffs to the actual individuals in need of the food continues to be a problem. One complication is that bulk quantities of foodstuffs (such as pallets of USAID foodstuffs) are attractive targets to be stolen or the like before reaching the victims. Food drops from aircraft of packaged meals also have not been without complications. Even when packaged meals are air-dropped successfully from a perspective of the meal packages reaching the ground in good condition and in what might be thought to be sufficient quantity for the population on the ground, there may still be a problem of stronger or armed individuals gathering the packages including taking from weaker individuals.

There remains an unmet need for emergency food relief distribution systems.

### SUMMARY OF THE INVENTION

In-shell peanuts have a relatively long shelf-life and the shell is relatively protective of the edible contents. In the invention, peanuts in the shell are delivered via air (such as, e.g., by being swept out of aircraft to drop, individually, to the ground; by being inserted in very small quantities into small balloons which are then helium-filled and set loose) to a population of victims needing food relief on an emergency basis.

The invention in one preferred embodiment provides an emergency food relief product, comprising: a balloon; and a quantity (such as, e.g., a single-serving quantity; a multiple-serving quantity, etc.) of food (such as, e.g., at least one in-shell peanut) disposed inside the balloon, such as, e.g., inventive products comprising an uninflated balloon; inventive products comprising an inflated balloon and further comprising a lifting gas (such as, e.g., a lifting gas that comprises helium) inside the inflated balloon; inventive products further comprising a popping mechanism (such as, e.g., a remote-controlled popping mechanism; a popping mechanism that self-activates at a pre-set time; etc.) that, when activated, pops the balloon; inventive products comprising a mixture of helium and ordinary air inside an inflated balloon; and other inventive products.

In another preferred embodiment, the invention provides a launcher apparatus for delivery of emergency food relief, comprising: a plurality of holding stations, wherein each holding station includes a structure to which is attachable at least one food-loaded, inflated balloon product; and a release mechanism in communication with the holding stations; such as, e.g., inventive launcher apparatuses that further comprise a computer system (such as, e.g., a computer system that performs one or more steps such as, e.g., receiving input data that identify a target geographic location to be aided; receiving data that describe a current location of the launcher apparatus; receiving data that describe current wind behavior at least in a vicinity of the current location of the launcher apparatus; based on the current wind behavior data, computing a projected trajectory of a balloon if launched from the current location of the launcher apparatus; computing whether the projected trajectory crosses the target geographic location, and if so, activating the release mechanism, and if not, repeating the computing steps at a later time); inventive launcher apparatuses wherein the plurality of holding stations are disposed on a ground-based frame (such as, e.g., a wheeled frame, a non-wheeled frame, etc.).

The invention in another preferred embodiment provides an emergency food relief method for delivery of emergency food relief to a target population at a first geographic location, comprising steps of: holding (such as, e.g., a holding step performed aboard a ship; a holding step performed aboard an off-road vehicle; etc.) a plurality of food-loaded balloons at a second geographic location which is separated by a distance from the first geographic location, wherein the holding step is performed by an apparatus; and wherein the apparatus continues to perform the holding step while a wind flow between the second geographic location and the first geographic location is unfavorable for the food-loaded balloons to reach the target population if released; and, when the wind flow between the second geographic location and the first geographic location is favorable for the food-loaded balloons to travel toward the target population if released, releasing the food-loaded balloons into the favorable wind flow; such as, e.g., inventive methods wherein whether wind flow between the second geographic location and the first geographic location is favorable for release is computed by a computer system and wherein the apparatus performs the releasing step after having received a release instruction from the computing system; inventive methods wherein the step of releasing the food-loaded balloons is preceded by a wind-direction measurement step that is performed (a) covering a substantial part of the distance between the first and second geographic locations, and (b) at about a distance above-ground that corresponds to about how high the balloons will travel based on a proportion of lifting gas in the balloons; and other inventive methods.

### BRIEF DESCRIPTION OF FIGURES

The invention may be appreciated with reference to the following figures, without the invention being limited thereto. Figures are not drawn to scale.

FIG. 1 is a perspective view of a preferred embodiment of the invention in a pre-assembly condition.

FIG. 2 corresponds to FIG. 1 in which the components have been assembled into a pre-launch packed condition.

FIG. 3 is a schematic diagram of an inventive holder/launcher apparatus for use with certain food-packed devices such as an inventive food-packed device according to FIG. 2.

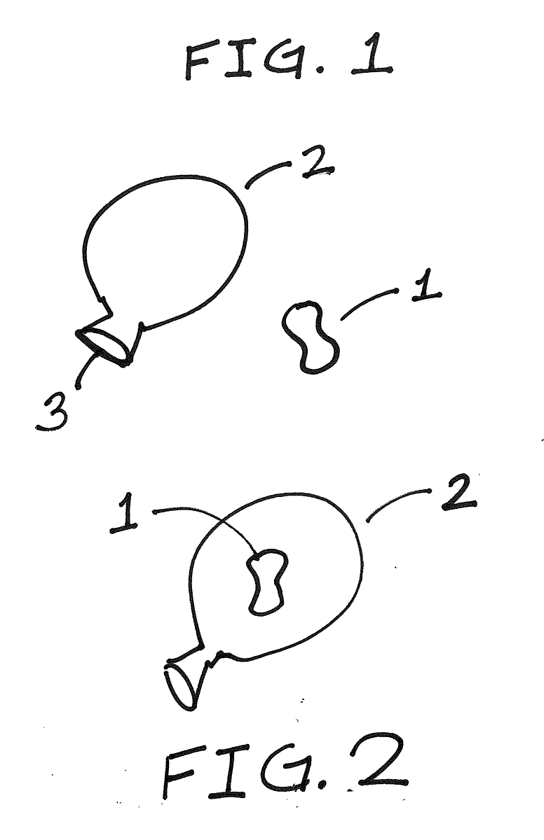

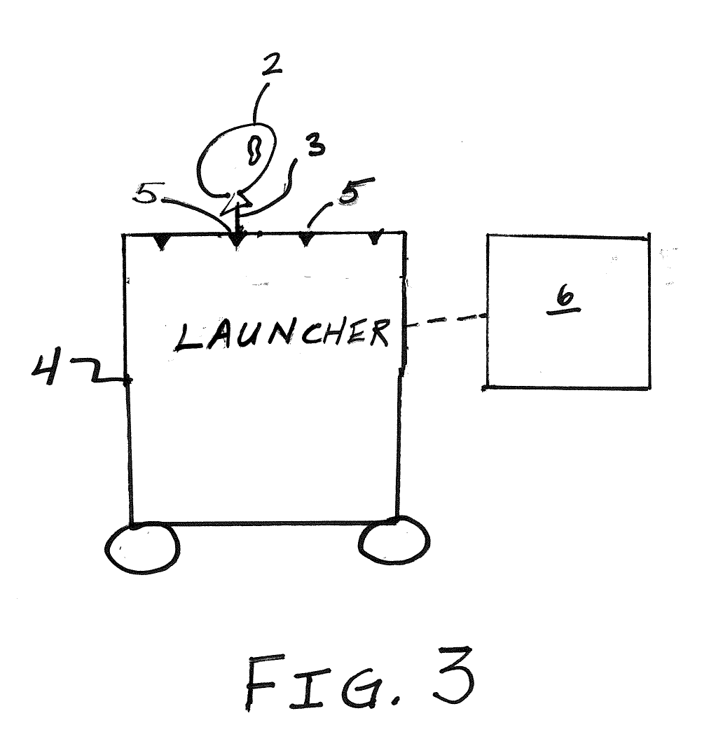

### DETAILED DESCRIPTION OF PREFERRED EMBODIMENT OF THE INVENTION

A quantity of food 1 is provided for use in the invention. A preferred example of the food 1 is an in-shell peanut.

An example of a quantity of food 1 is, e.g., a single in-shell peanut, a single food item, multiple in-shell peanuts, multiple food items, etc.

In a preferred example of a delivery system for delivering the food 1 to a human in need of emergency food relief, a balloon 2 comprising an opening 3 is provided and the food 1 is inserted into the opening 3 so that the food 1 is inside the balloon 2, which is then inflated. The inflated balloon is closed-up. The closed-up, inflated balloon is released from a geographical location which geographical location is selected to be upwind of the population needing emergency food relief so that the balloon travels downwind towards the population needing food.

Preferably the balloon 2 has thereon a message that expresses, in a language of an intended target population to be relieved, that the balloon 2 has food inside.

The invention may be further appreciated with reference to the following examples.

### Comparative Example 1 (Plumpy'nut)

Plumpy'nut is a commercially produced therapuetic packaged foodstuff that comprises peanut paste, vegetable oil, powdered milk, powdered sugar, vitamins, and minerals. Plumpy'nut paste is durably packaged in individual 92 g sachets. 150 of the sachets are then packaged into a carton. Then 56 cartons are packed into a pallet for container transport, or 48 cartons are packed into a pallet for air transport. Pallets and cartons of Plumpy'nut are valuable and susceptible to being stolen.

### Inventive Example 1

In this example, a quantity of in-shell peanuts are loaded into an aircraft which is flown over a geographic area having victims needing food relief. At the time immediately prior to the peanuts being released from the aircraft, the peanuts are not bagged or otherwise combined together. When the aircraft is over the geographic area, the individual in-shell peanuts are swept out (or otherwise projected from) the aircraft, to free-fall as individual in-shell peanuts to the ground. Once on the ground, the in-shell peanuts are available for pick up by the victims. A victim picking up an in-shell peanut can immediately remove the shell and consume the edible contents.

### Inventive Example 2

In this example, one or a few in-shell peanuts are pushed into a balloon. At a location on the ground upwind of a population of victims needing food relief, helium is added to the peanut-containing balloon and the thus-prepared balloon is released to travel downwind towards the victims.

### Inventive Example 3

In this example, a quantity of a lifting gas (such as helium) and a quantity of ordinary air (which is less costly than helium) is received into the balloon.

### Inventive Example 4

In this example, a food-loaded balloon 2 has attached to it a clipping device 3 (such as, e.g., a clothes-pin structure, a clamp structure, etc.). The clipping device 3 comprises a first end which is a balloon-holding end at which the balloon 2 is held, and a second end which is received into or held by the launching structure 4 at a holding station 5. Preferably a plurality of stations 5 are provided in the launcher 4.

Preferably holding stations 5 are readily accessible by human workers installing food-loaded balloons 2 onto the launcher 4.

Optionally launcher 4 includes a release mechanism (not shown) in communication with the holding stations 5.

Optionally launcher 4 is wheeled or includes wheels or a vehicle. Launcher 4 is not required to include a vehicle or to be wheeled.

### Inventive Example 4A

Preferably launcher 4 comprises, or is connected to, or is connectible to, a computerized system 6, such as, e.g., a computerized system that performs one or more steps such as, e.g.: receiving input data that identify a target geographic location to be aided; receiving data that describe a current location of the launcher; receiving data that describe current wind behavior at least in a vicinity of the current location of the launcher; based on the current wind behavior data, computing a projected trajectory of a balloon if launched from the current location of the launcher; computing whether the projected trajectory crosses the target geographic location, and if so, activating a release mechanism, and if not, repeating the computing steps at a later time; etc.

While the invention has been described in terms of a preferred embodiment, those skilled in the art will recognize that the invention can be practiced with modification within the spirit and scope of the appended claims.

What I claim as my invention is:

1. An emergency food relief product, comprising:
a balloon;
a quantity of food disposed inside the balloon.

2. The emergency food relief product of claim 1, wherein the food is at least one in-shell peanut.

3. The emergency food relief product of claim 1, wherein the balloon is uninflated.

4. The emergency food relief product of claim 1, wherein the balloon is inflated.

5. The emergency food relief product of claim 4, further comprising a lifting gas inside the inflated balloon.

6. The emergency food relief product of claim 5, wherein the lifting gas comprises helium.

7. The emergency food relief product of claim 1, wherein the quantity of food is a single-serving.

8. The emergency food relief product of claim 1, wherein the quantity of food is a multiple-serving quantity.

9. The emergency food relief product of claim 1, further comprising a popping mechanism that, when activated, pops the balloon.

10. The emergency food relief product of claim 9, wherein the popping mechanism is remote-controlled.

11. The emergency food relief product of claim 9, wherein the popping mechanism self-activates at a pre-set time.

12. The emergency food relief product of claim 6, wherein inside the inflated balloon is a mixture of helium and ordinary air.

13. The emergency food relief product of claim 1, further comprising a message, on the balloon, wherein the message expresses, in a language of an intended target population to be relieved, that the balloon has food inside.

14. A launcher apparatus for delivery of emergency food relief, comprising:
a plurality of holding stations, wherein each holding station includes a structure to which is attachable at least one food-loaded, inflated balloon product; and
a release mechanism in communication with the holding stations.

15. The launcher apparatus of claim 14, further comprising a computer system, wherein the computer system performs steps of:
receiving input data that identify a target geographic location to be aided;
receiving data that describe a current location of the launcher apparatus;
receiving data that describe current wind behavior at least in a vicinity of the current location of the launcher apparatus;
based on the current wind behavior data, computing a projected trajectory of a balloon if launched from the current location of the launcher apparatus;
computing whether the projected trajectory crosses the target geographic location, and if so, activating the release mechanism, and if not, repeating the computing steps at a later time.

16. The launcher apparatus of claim 14, wherein the plurality of holding stations are disposed on a ground-based frame.

17. An emergency food relief method for delivery of emergency food relief to a target population at a first geographic location, comprising steps of:
holding a plurality of food-loaded balloons at a second geographic location which is separated by a distance from the first geographic location, wherein the holding step is performed by an apparatus; and wherein the apparatus continues to perform the holding step while a wind flow between the second geographic location and the first geographic location is unfavorable for the food-loaded balloons to reach the target population if released;
when the wind flow between the second geographic location and the first geographic location is favorable for the food-loaded balloons to travel toward the target population if released, releasing the food-loaded balloons into the favorable wind flow.

18. The method of claim 17, wherein the holding step is performed aboard a ship or an off-road vehicle.

19. The method of claim 17, wherein whether wind flow between the second geographic location and the first geographic location is favorable for release is computed by a computer system, and wherein the apparatus performs the releasing step after having received a release instruction from the computing system.

20. The method of claim 17, wherein the step of releasing the food-loaded balloons is preceded by a wind-direction measurement step that is performed (a) covering a substantial part of the distance between the first and second geographic locations, and (b) at about a distance above-ground that corresponds to about how high the balloons will travel based on a proportion of lifting gas in the balloons.
